(19) United States
(12) Patent Application Publication
(10) Pub. No.: US 2025/0125283 A1
(43) Pub. Date: Apr. 17, 2025

(54) CHIP WITH GENERAL-PURPOSE INPUT/OUTPUT PORT CONNECTED TO METAL SURFACE FOR CARRIER MOUNTING

(71) Applicant: Infineon Technologies AG, Neubiberg (DE)

(72) Inventors: Armin Krieg, Graz (AT); Christoph Saas, Muenchen (DE); Josef Haid, Graz (AT)

(21) Appl. No.: 18/913,488

(22) Filed: Oct. 11, 2024

(30) Foreign Application Priority Data
Oct. 12, 2023 (DE) 102023127943.2

(51) Int. Cl. H01L 23/00; G06F 21/60

(52) U.S. Cl. CPC H01L 23/573; G06F 21/602; H10D 1/692

(57) ABSTRACT

A chip configured to be mounted on a carrier. The chip includes a die having an input/output circuit and a general-purpose input/output port, wherein the general-purpose input/output port is electrically conductively connected to the input/output circuit of the die. The chip further includes a package in which the die is at least partially embedded, and at least one metal surface on a mounting side of the chip, wherein the mounting side faces the carrier during mounting, wherein a size of the at least one metal surface is at least 10% of a size of the mounting side, and wherein the general-purpose input/output port is furthermore electrically conductively connected to the at least one metal surface.

### TECHNICAL FIELD

The disclosure relates to a chip and to a chip system.

### BACKGROUND

Nowadays, with electronic devices, there is an interest in allowing them to operate or to interact with consumables and/or spare parts (for example that are to be replaced regularly) only if an original device, original consumable, and/or original spare part is used, and not for instance a generally less expensive clone.

One field that is known for this problem is that of printers in which ink cartridges and toner cartridges have to be replaced regularly.

To provide protection against the use of cloned products from other manufacturers, typically either an intellectual property right is acquired, which may be enforceable in markets, or use is made of technical features that are either not able to be analyzed, are difficult to replicate or are provided with high production costs, or a combination thereof.

In order to protect intellectual property, the features must be easily recognizable, and infringement of the intellectual property right must be clearly identifiable.

Existing solutions use for example copyrighted interfaces or special coatings, for example of chip packages that are able to be recognized in the system (for example a device).

However, analyzing the special coatings means, in particular, that it is necessary to provide additional sensors, which increases manufacturing costs.

### SUMMARY

In various exemplary aspects, provision is made for a chip that provides a measurable characteristic of the die (also referred to as the bare chip), which interacts with its package, and with a carrier on which the chip is mounted.

According to various exemplary aspects, this is achieved by misappropriating a metal surface (or possibly multiple metal surfaces), which is configured as a ground contact (ground, GND, earthing contact) in many state-of-the-art chips, by virtue of connecting the one or more metal surfaces not to a ground contact of the die, but rather to a general-purpose input/output port of the die. This forms a virtual capacitor.

According to various exemplary aspects, on the carrier side (the carrier may for example be or comprise a printed circuit board (PCB)), this, which according to the prior art is likewise provided as a ground contact plate, may be connected to a pin of the carrier in order to provide a connection for the virtual capacitor on the carrier side as well.

It is thereby possible, either on the side of the carrier (which may, for example, be part of a base device) or on the side of the die, to measure an analog (for example, physical, for example electrical) property of the die interacting with the package and the carrier (for example the PCB).

In various exemplary aspects, provision is made for a chip that is configured to be mounted on a carrier (for example on a PCB of a device such as for example a printer cartridge or the like). The chip comprises a die having an input/output circuit and a general-purpose input/output (GPIO) port, wherein the general-purpose input/output port is electrically conductively connected to the input/output circuit of the die. The chip furthermore comprises a package in which the die is at least partially embedded, and at least one metal surface on a mounting side of the chip, wherein the mounting side faces the carrier during mounting, and wherein a size of the at least one metal surface is at least 10% of a size of the mounting side, and wherein the general-purpose input/output port is furthermore electrically conductively connected to the at least one metal surface.

The metal surface, which is typically connected to a ground contact of the die according to the prior art, typically occupies an appreciable portion of the surface area of the mounting side of the chip. For this reason, the above 10% portion of the surface area is specified for the purpose of identifying the metal surface of the chip that is actually provided for the ground contact.

According to various exemplary aspects, the at least one metal surface may be formed as a single contiguous surface, similar to the prior art. According to other exemplary aspects, the at least one metal surface may comprise two or more metal surfaces that are each electrically conductively connected to the general-purpose input/output port and together make up the portion of the surface area of at least 10% of the size of the mounting side.

If necessary, other or additional properties may be used to identify the actual ground contact. By way of example, this is often arranged centrally and/or forms the largest metal (contact) surface of the chip.

The large size of the at least one metal surface (with the portion of the surface area of more than 10% of the size of the mounting side and/or that the at least one metal surface (in the case of multiple metal surfaces with regard to their summed surface area) is the largest of the contact surfaces) may have an advantageous effect on signal strength and quality when measuring a capacitance between the at least one metal surface and at least one carrier metal surface.

### BRIEF DESCRIPTION OF THE DRAWINGS

Exemplary aspects of the disclosure are illustrated in the figures and are explained in more detail below.

In the figures:

FIG. 1A shows a schematic cross-sectional view of a chip according to various exemplary aspects;

FIG. 1B shows a schematic cross-sectional view of a chip device according to various exemplary aspects;

FIG. 2 shows a circuit diagram of a chip system according to various exemplary aspects;

FIG. 3A shows a schematic cross-sectional view of a chip according to various exemplary aspects;

FIG. 3B shows a schematic cross-sectional view of a chip device according to various exemplary aspects; and

FIG. 4 shows a circuit diagram of a chip device according to various exemplary aspects.

### DETAILED DESCRIPTION

In the detailed description that follows, reference is made to the accompanying drawings, which form part of said description and show, for illustration, specific aspects in which the aspects of the disclosure may be performed. In this regard, direction terminology such as, for instance, “at the top”, “at the bottom”, “at the front”, “at the back”, “front”, “rear”, etc. is used with respect to the orientation of the one or more figures described. Since components of aspects may be positioned in a number of different orientations, the directional terminology is used for illustration and is not restrictive in any way. It goes without saying that other aspects may be used, and structural or logical changes may be made, without departing from the scope of protection of the aspects of the present disclosure. It goes without saying that the features of the various exemplary aspects described herein may be combined with one another unless specifically stated otherwise. The detailed description that follows should, therefore, not be interpreted in a restrictive sense, and the scope of protection of the aspects of the present disclosure is defined by the attached claims.

Within the scope of this description, the terms “connected” and “coupled” are used to describe both a direct and an indirect connection and direct or indirect coupling. In the figures, identical or similar elements are provided with identical reference signs if expedient.

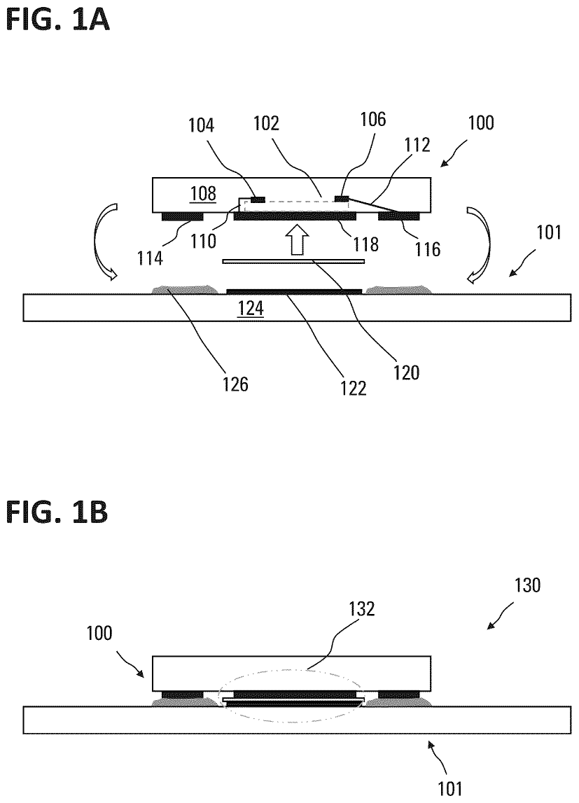

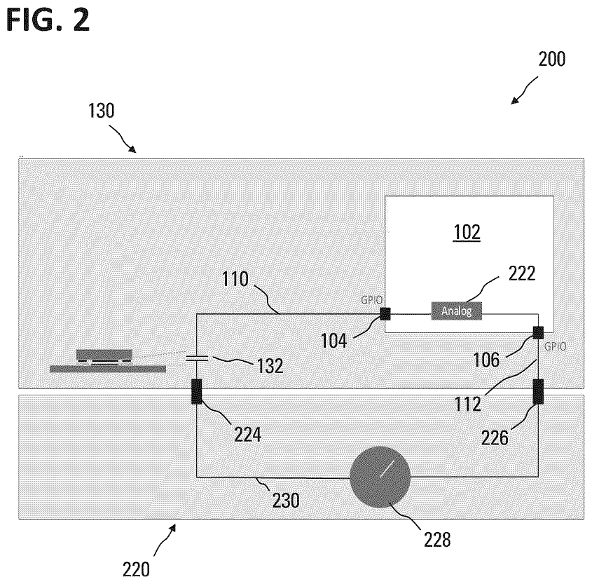

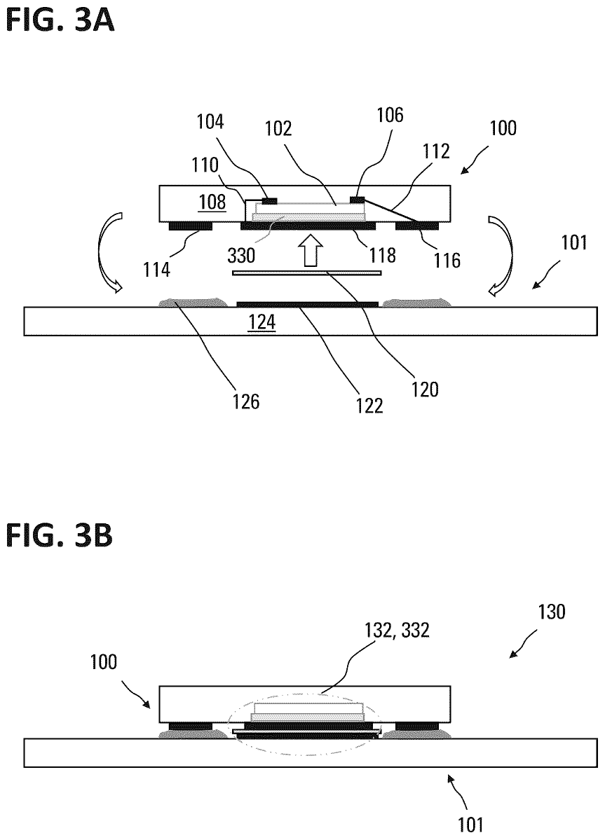

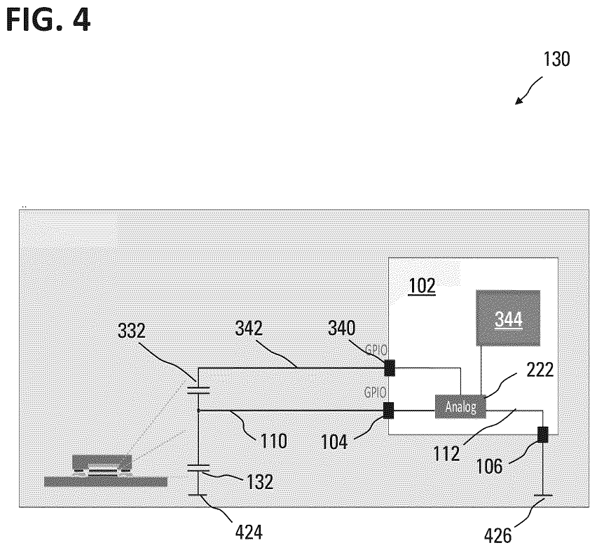

FIGS. 1A and 3A each show a schematic cross-sectional view of a chip 100 according to various exemplary aspects, FIG. 1B and FIG. 3B each show a schematic cross-sectional view of a chip device 130 according to various exemplary aspects, FIG. 2 shows a circuit diagram of a chip system 200 according to various exemplary aspects, and FIG. 4 shows a circuit diagram of a chip device 130 according to various exemplary aspects.

The chip 100 is configured to be mounted on a carrier 101, for example, a printed circuit board (PCB).

The chip 100 comprises a die 102 having an input/output circuit and a general-purpose input/output port 104, wherein the general-purpose input/output port 104 is electrically conductively connected to the input/output circuit of the die 102.

The chip 100 furthermore comprises a package 108 in which the die 102 is at least partially embedded.

The package 108 may, for example, comprise an electrically insulating material that is similar or identical to a material of a package according to the prior art. By way of example, the package 108 may comprise an encapsulating material, for example, a molding material, which may, for example, be injection-molded.

The chip 100 furthermore comprises at least one metal surface 118 on a mounting side of the chip 100.

The mounting side of the chip 100 is the side that faces the carrier 101 when the chip 100 is mounted on the carrier 101.

By way of example, the mounting side may be one of two main sides of the chip 100. The second main side may be opposite the mounting side and may also be referred to as the top side.

The mounting side may include one or more exposed contact surfaces 114, 116 that are configured to electrically conductively connect the chip 100 to the carrier 101. As an alternative or in addition, contacts may be provided on at least one of the other sides of the chip 100, for example projecting from the package.

The at least one metal surface 118 may be the one or more metal surfaces of the chip 100 that is (or are) typically connected to a ground contact of the die 102 according to the prior art.

It typically occupies an appreciable portion of the surface area of the mounting side of the chip 100, for example, 10%, 20%, or more, for example, 50%. Accordingly, the above 10% portion of the surface area is specified for the purpose of identifying the one or more metal surfaces of the chip 100 that is or are provided for the ground contact in the prior art. In this case, a portion of the surface area of at least 10% of the mounting side means that 10% or more is covered by the at least one metal surface 118 when looking at the mounting side from above.

If necessary, other or additional properties may be used to identify the “actual ground contact”. By way of example, this is often arranged centrally and/or forms the largest metal (contact) surface of the chip 100.

The general-purpose input/output port 104 is furthermore electrically conductively connected to the at least one metal surface 118, for example, by way of an electrically conductive connection 110. In the case of multiple metal surfaces 118 (for example, in the case of a division into multiple segments), each of the metal surfaces 118 is electrically conductively connected to the general-purpose input/output port 104.

The at least one metal surface 118 may, in various exemplary aspects, be formed or arranged directly on the die 102 (see in this regard the exemplary aspect from FIG. 1A and FIG. 1B), for example, on its semiconductor material. As an alternative, the at least one metal surface 118 may be arranged separately from the semiconductor material of the die 102 (for example electrically insulated therefrom) (see in this regard the exemplary aspect from FIG. 3A and FIG. 3B), for example by virtue of the at least one metal surface 118 being attached to the die 102 by way of an electrically insulating layer 330 or the at least one metal surface 118 being formed on an outside of the package 108 (in that case, the insulating layer 330 would be formed of packaging material).

FIGS. 1B and 3B each show how, according to various exemplary aspects, the chip 100 is arranged on the carrier 101 so as to form the chip device 130.

The carrier 101 may, for example, be a printed circuit board or comprise a printed circuit board. The carrier 101 may comprise carrier material 124 on which at least one carrier metal surface 122 may be arranged. The carrier metal surface 122 may be the one that, according to the prior art, would be provided for the purpose of providing a ground contact for the chip 100. According to various exemplary aspects, the at least one carrier metal surface 122 is, however, electrically conductively connected to another contact 224 that is able to be contacted from the outside. In the case of multiple carrier metal surfaces 122, each of the carrier metal surfaces 122 is electrically conductively connected to the contact 224.

According to various exemplary aspects, the at least one metal surface 118 is however not soldered to the at least one carrier metal surface 122 (and also not connected electrically conductively directly thereto in any other way), but rather the at least one metal surface 118 and the at least one carrier metal surface 122 are arranged so as to be electrically insulated from one other, for example by virtue of an electrically insulating material 120 being arranged between the at least one metal surface 118 and the at least one carrier metal surface 122.

The electrically insulating material 120 may be arranged on the at least one metal surface of the chip 100 or, for example, during mounting of the chip 100 on the carrier 101, be arranged between the at least one metal surface 118 and the at least one carrier metal surface 122.

The electrically insulating material 120 may comprise or consist of an electrically insulating adhesive, an electrically insulating lacquer, an oxide layer, a polymer layer, and/or an electrically insulating thermally conductive material.

The at least one metal surface 118 and the at least one carrier metal surface 122 are arranged relative to one another such that they form a (virtual) capacitor 132, which is electrically conductively connected (by way of its capacitor plate formed by the at least one metal surface 118), on the one hand, to an analog circuit 222 within the die 102.

The other capacitor plate, which is formed by the at least one carrier metal surface 122, may be electrically conductively connected directly to the carrier 101, for example a circuit 230, 228 of the carrier 101.

The at least one metal surface 118, the at least one carrier metal surface 122 (which forms the capacitor 132), the connecting lines 110, 112 in the chip 100, in the die 102 (for example the analog circuit 222 contained therein) and a (sub)circuit 230, 228 of a base device 220 may thus together form a measuring circuit that is configured to measure a capacitance of the capacitor 132.

The chip device 130 may be configured to measure an interaction between the analog circuit of the die 102 and the (virtual) capacitor 132.

FIG. 2 and FIG. 4 each show implementations of a chip system 200 that is configured to measure the capacitance of the capacitor 132.

The analog circuit 222 may for example comprise a simple circuit such for example a switch, or for example a more complex circuit able to be controlled by software of the die 102.

The analog circuit 222 makes it possible to trigger different interactions with the virtual capacitor 132 in the field (for example, during use by a user), all of which would have to be reproduced by a planned clone.

In particular, late activation of various circuits (that is to say activation with a time delay in relation to a delivery, for example, by way of the analog circuit 222) may pose challenges to clones, since a chip device 130 that is analyzed in order to be able to clone it might, immediately after it has been manufactured, not yet show all properties that may be required later during operation thereof in order to verify it.

Data representing this measurement result may be signed cryptographically (for example, during manufacture of the chip device 130) and stored in the die 102, which may be formed, for example, as a security chip (also referred to as a secure element and configured to provide cryptographic functions). A crypto-module 344 is shown, at least in FIG. 4, as part of the die 102 by way of illustration of the cryptographic functions.

In various exemplary aspects, the base device 220 may be given the ability to identify, for example, by way of a processor, whether a clone, for example, copies only a single carrier-die interaction, since manufacturing tolerances, concerning, for example, a size of a virtual capacitor, vary from product to product.

Using cryptography to protect a stored analog “fingerprint” may prevent any behavior from simply being copied.

The chip device 130 may be configured to provide a function to be provided thereby only if a capacitance measured during operation (for example only once at initial commissioning or repeatedly, for example at each commissioning or at defined time intervals) matches the stored measurement results, which may serve as a reference value, within the measurement tolerances.

The chip device 130 may, for example, be an accessory for a chip system 200, which comprises a base device 220 in addition to the chip device 130; furthermore, for example, the base device 220 may be a printer, and the chip device 130 may be a toner cartridge or ink cartridge.

A manufacturer attempting to clone the chip device 130 also has to clone the behavior of the capacitor 132, the characterization of which is stored in the form of the measured values in the die 102, resulting in increased costs for the production of the clones.

In contrast, providing the measured values requires no or, at most, little additional financial expenditure since currents and/or voltages only need to be compared with one another, which is within the usual sensor scope of a chip device 130.

In various exemplary aspects, a material, for example, a dielectric, may be predetermined for the electrically insulating material 120. The properties thereof may likewise influence the measurements, which makes cloning even more difficult, since typically, to examine how a chip device 200 needs to be cloned, the chip device 200 is disassembled, which means that the measured values are not able to be reproduced.

FIGS. 3A, 3B and 4 describe an expansion of the concept explained with reference to FIGS. 1A, 1B, and 2 by way of example.

In this case, in addition to the capacitor 132 between the metal layer 118 and the carrier metal layer 222, a second capacitor 332 is provided between a semiconductor material (for example silicon) of the die 102 and the metal layer 118.

In this case, the metal layer 118 may be adhesively bonded to the die 102, for example by way of an insulating (and not conductive like in the prior art) adhesive 330.

According to various exemplary aspects, which are illustrated by way of example in FIG. 4, the at least one carrier metal surface 122 is actually electrically conductively connected to a ground contact (GND) 424.

In this case, the die 102 may be configured to measure a capacitance between the semiconductor material of the die 102, the package 108 (or the metal layer 118), and the carrier metal layer 122 in order to detect anomalies.

Optionally, it is also possible to use the measurement results for the capacitances as a product-specific “fingerprint” that is able to be used for cryptographic functions, for example, in a die that is designed as a secure element and that may, for example, comprise a crypto-module 344.

Some exemplary aspects are specified in summary below.

Exemplary aspect 1 is a chip configured to be mounted on a carrier. The chip comprises a die having an input/output circuit and a general-purpose input/output port, wherein the general-purpose input/output port is electrically conductively connected to the input/output circuit of the die. The chip furthermore comprises a package in which the die is at least partially embedded, and at least one metal surface on a mounting side of the chip, wherein the mounting side faces the carrier during mounting, and wherein a size of the at least one metal surface is at least 10% of a size of the mounting side, and wherein the general-purpose input/output port is furthermore electrically conductively connected to the at least one metal surface.

Exemplary aspect 2 is a chip according to exemplary aspect 1, furthermore comprising an insulating layer that is arranged above the at least one metal surface and that insulates the at least one metal surface from an outside of the chip.

Exemplary aspect 3 is a chip according to exemplary aspect 1 or 2, wherein the insulating layer comprises at least one material of a group of materials, wherein the group consists of an electrically insulating adhesive, an electrically insulating lacquer, an oxide layer, a polymer layer and an electrically insulating thermally conductive material.

Exemplary aspect 4 is a chip according to one of the preceding exemplary aspects, furthermore comprising a package contact that is exposed on an outside of the chip and that is electrically conductively connected to an additional general-purpose input/output port of the die.

Exemplary aspect 5 is a chip according to one of the preceding exemplary aspects that is configured, by way of the at least one metal surface, to enable a measurement of a first capacitance of a first capacitor formed of the at least one metal surface and at least one carrier metal surface arranged opposite the at least one metal surface.

Exemplary aspect 6 is a chip according to one of the preceding exemplary aspects, wherein the die is configured to provide a reference capacitance value to a comparison circuit.

Exemplary aspect 7 is a chip according to exemplary aspect 6, wherein the die is formed as a security element, and wherein the reference capacitance value is stored in the security element.

Exemplary aspect 8 is a chip according to exemplary aspect 7, wherein the die is configured to provide the reference capacitance value in a cryptographically secured manner.

Exemplary aspect 9 is a chip according to one of the preceding exemplary aspects, wherein the general-purpose input/output port is configured to be connected to a static or a dynamically changing potential.

Exemplary aspect 10 is a chip according to one of the preceding exemplary aspects, wherein the at least one metal surface is arranged in direct contact with a semiconductor body of the die.

Exemplary aspect 11 is a chip according to one of exemplary aspects 1 to 9, wherein the at least one metal surface is arranged so as to be electrically insulated from a semiconductor body of the die.

Exemplary aspect 12 is a chip according to exemplary aspect 11, furthermore configured to determine a second capacitance of a second capacitor formed of the semiconductor body and the at least one metal surface.

Exemplary aspect 13 is a chip device. The chip device comprises a carrier having at least one carrier metal surface and a chip according to one of exemplary aspects 1 to 12, wherein the chip is attached to the carrier such that the at least one carrier metal surface is arranged opposite the at least one metal surface and the at least one metal surface forms a capacitor with the at least one carrier metal surface.

Exemplary aspect 14 is a chip device according to exemplary aspect 13, wherein the at least one metal surface and the at least one carrier metal surface are part of a measuring circuit that is configured to determine a capacitance value of the capacitor.

Exemplary aspect 15 is a chip device according to exemplary aspect 13 or 14, wherein the die is configured to determine the capacitance value.

Exemplary aspect 16 is a chip device according to exemplary aspect 15, wherein the die is furthermore configured to compare a reference capacitance value with the determined capacitance value.

Exemplary aspect 17 is a chip device according to exemplary aspect 13 or 14, furthermore comprising an additional die, wherein the additional die is configured to determine the capacitance value.

Exemplary aspect 18 is a chip device according to exemplary aspect 17, wherein the additional die is furthermore configured to compare a reference capacitance value with the determined capacitance value.

Exemplary aspect 19 is a chip device according to exemplary aspect 16 or 18, configured to selectively provide a function, and furthermore configured to enable or deny the provision of the function based on a result of the comparison.

Exemplary aspect 20 is a chip system. The chip system comprises a chip device according to one of exemplary aspects 13 to 19 and a base device having a sub-measuring circuit, wherein the sub-measuring circuit of the base device and the chip device are electrically conductively connected to one another such that the capacitor and the sub-measuring circuit form part of a measuring circuit for determining the capacitance value of the capacitor.

Exemplary aspect 21 is a chip system according to exemplary aspect 20, wherein the chip device is an accessory for the base device, for example a dispensing unit for a consumable.

Exemplary aspect 22 is a chip system according to exemplary aspect 20 or 21, wherein the chip device is an ink cartridge or toner cartridge, and the base device is a printer.

Exemplary aspect 23 is a chip system according to exemplary aspect 20 or 21, wherein the chip device is a consumable container of an e-cigarette, and the base device is an e-cigarette base module.

Further advantageous configurations of the device are evident from the description of the method, and vice versa.

1. A chip configured to be mounted on a carrier, the chip comprising:
a die having an input/output circuit and a general-purpose input/output port, wherein the general-purpose input/output port is electrically conductively connected to the input/output circuit of the die;
a package in which the die is at least partially embedded;
at least one metal surface on a mounting side of the chip, wherein the mounting side of the chip faces the carrier during mounting, and wherein a size of the at least one metal surface is at least 10% of a size of the mounting side; and
an insulating layer that is arranged above the at least one metal surface and that insulates the at least one metal surface from an outside of the chip,
wherein the general-purpose input/output port is electrically conductively connected to the at least one metal surface.

2. The chip as claimed in claim 1, further comprising:
a package contact that is exposed on an outside of the chip and that is electrically conductively connected to an additional general-purpose input/output port of the die.

3. The chip as claimed in claim 1,
wherein the die is configured to provide a reference capacitance value to a comparison circuit,
wherein the die is formed as a security element, and
wherein the reference capacitance value is stored in the security element.

4. The chip as claimed in claim 3,
wherein the die is configured to provide the reference capacitance value in a cryptographically secured manner.

5. The chip as claimed in claim 1,
wherein the at least one metal surface is arranged in direct contact with a semiconductor body of the die.

6. The chip as claimed in claim 1,
wherein the at least one metal surface is arranged so as to be electrically insulated from a semiconductor body of the die.

7. A chip device, comprising:
a carrier having at least one carrier metal surface; and
a chip as claimed in claim 1,
wherein the chip is attached to the carrier such that the at least one carrier metal surface is arranged opposite the at least one metal surface and the at least one metal surface forms a capacitor with the at least one carrier metal surface.

8. The chip device as claimed in claim 7,
wherein the at least one metal surface and the at least one carrier metal surface are part of a measuring circuit that is configured to determine a capacitance value of a first capacitor formed of the at least one metal surface and the at least one carrier metal surface.

9. The chip device as claimed in claim 7,
where the die is configured to determine the capacitance value.

10. The chip device as claimed in claim 9,
wherein the die is further configured to compare a reference capacitance value with the determined capacitance value.

11. The chip device as claimed in claim 7, further comprising:
an additional die,
where the additional die is configured to determine the capacitance value.

12. The chip device as claimed in claim 11,
wherein the additional die is further configured to compare a reference capacitance value with the determined capacitance value.

13. The chip device as claimed in claim 10, configured to selectively provide a function, and further configured to enable or deny the provision of the function based on a result of the comparison.

14. A chip system, comprising:
a chip device as claimed in claim 7; and
a base device having a sub-measuring circuit,
wherein the sub-measuring circuit of the base device and the chip device are electrically conductively connected to one another such that the capacitor and the sub-measuring circuit form part of a measuring circuit for determining the capacitance value of the capacitor.

15. The chip system as claimed in claim 14,
where the chip device is an accessory for the base device.
